(19) United States
(12) Patent Application Publication
(10) Pub. No.: US 2007/0041642 A1
(43) Pub. Date: Feb. 22, 2007

(54) POST-OCR IMAGE SEGMENTATION INTO SPATIALLY SEPARATED TEXT ZONES

(76) Inventors: Harris Gabriel ROMANOFF, Narberth, PA (US); Leslie SPERO, Merion Station, PA (US); Sarabjit SINGH, Uttaranchal (IN)

Correspondence Address: rudoler & derosa llc;ATTN: DOCKET CLERK, 2 BALA PLAZA,, SUITE 300, BALA CYNWYD, PA, 19004, US

(21) Appl. No.: 11/465,505

(22) Filed: Aug. 18, 2006

Related U.S. Application Data
(60) Provisional application No. 60/709,302, filed on Aug. 18, 2005.

(51) Int. Cl. G06K 9/34

(52) U.S. Cl. 382/177

(57) ABSTRACT

This invention describes a post-recognition procedure to group text recognized by an Optical Character Reader (OCR) from a document image into zones. Once the recognized text and the corresponding word bounding boxes for each word of the text are received, the procedure described dilates (expands) these word bounding boxes by a factor and records those which cross. Two word bounding boxes will cross upon dilation if the corresponding words are very close to each other on the original document. The text is then grouped into zones using the rule that two words will belong to the same zone if their word bounding boxes cross upon dilation. The text zones thus identified are sorted and returned.

### CROSS REFERENCE TO RELATED APPLICATION

The present application claims the benefit of U.S. Provisional Application No. 60/709,302 filed on Aug. 18, 2005, which is incorporated herein by reference.

### BRIEF SUMMARY OF THE INVENTION

A computer based method, and system for implementing this method, for grouping text into logical word groups are disclosed. The method and system involve scanning a document with text into a computer, processing the image with OCR software to generate word and word edges, creating word bounding boxes around each word, dilating the word bounding boxes and grouping together the words that have intersecting dilated boxes.

### BACKGROUND OF THE INVENTION

Image segmentation refers to the process of slicing an image into multiple, usually spatially disjoint, segments. Though there are many applications that could make use of this process—to identify areas of different colors for example—the present invention is concerned with the segmentation of images containing text.

In certain applications that rely on text extraction from document images, text in different places on an image often needs to be handled differently. For example, words on the top of a document such as in an invoice, might need to be considered as the header and those below as the body. Or the text might be distributed in multiple columns, such as in a newspaper article, that need to be read separately one after the other. This requirement can become exceptionally difficult to fulfill, especially in the latter scenario, when edges of such columns are not straight and text is arbitrarily distributed over the document instead. For example, unless special differences are taken into account, two lines in the same row, i.e. at the same horizontal level, but in different columns and hence completely out of context with each other, will be put together in the same line when the text is scanned and interpreted through an optical character recognition (OCR) algorithm. Unless the image is segmented into different zones, the OCR algorithm will yield a jumbled, and possibly meaningless, output. What is required therefore is a process that accepts image as its input and returns the recognized text categorized as a set of disjoint text zones. In addition to newspapers and product invoices, this process can also be applied to other kinds of documents like business cards, receipts, bank checks, printed articles/reports and web pages.

A number of solutions to this problem have been developed. U.S. Pat. No. 6,470,095 discusses an approach that analyzes the pixel map of the input image and groups together areas close to each other using a “sufficient stability grouping technique.” U.S. Pat. No. 5,537,491 describes another pixel level approach which runs an iterative process to determine a threshold which will produce the most stable grouping of objects on the image. Yet another related procedure which works directly on the image pixels to identify word boundaries has been described in U.S. Pat. No. 5,321,770.

A common approach to grouping text into zones makes use of histograms—vertical and/or horizontal projection of the image data onto the horizontal and vertical axes—to identify words/objects which are close to each other. This approach could be employed at the pixel level (as in U.S. Pat. No. 5,848,184) or at the macro/word level (as in U.S. Pat. No. 6,006,240). U.S. Pat. No. 5,889,886 discusses yet another method to identify separate areas of text using similarity in width of the columns in which it is distributed.

### BRIEF DESCRIPTION OF THE DRAWINGS

FIG. 1 shows a flowchart of the method of the invention.

FIG. 2 shows a document that contains text present in multiple spatially-separated zones.

FIG. 3 shows the word bounding boxes on the scanned image.

FIG. 4 shows how the word bounding boxes on the scanned image overlap upon dilation.

FIG. 5 shows the word graph corresponding to the scanned image.

FIG. 6 shows the connected components of the word graph.

FIG. 7 shows how there is a one-to-one correspondence between the connected components of the word graph and the text zones on the scanned image.

### DETAILED DESCRIPTION OF THE INVENTION

This invention describes an image segmentation procedure that separates the text into multiple zones. Unlike many methods developed to achieve a similar purpose however, in the preferred embodiment, it does not work on the pixel level, but may use of the results returned by various commercially available OCR programs. The invention makes use of a “dilation” procedure to identify close words. This document then describes a graph-based algorithm to group these words together into zones, although other publicly-available methods to group these words also exist.

For example, using a series of nested loops to group together words that are close—a standard though arguably not the most efficient procedure. Another way to perform this grouping is by using set theory—a relation can be defined over whether two words are close after dilation. Using this relationship, the set of words can be partitioned into equivalence classes each of which will correspond to a text zone.

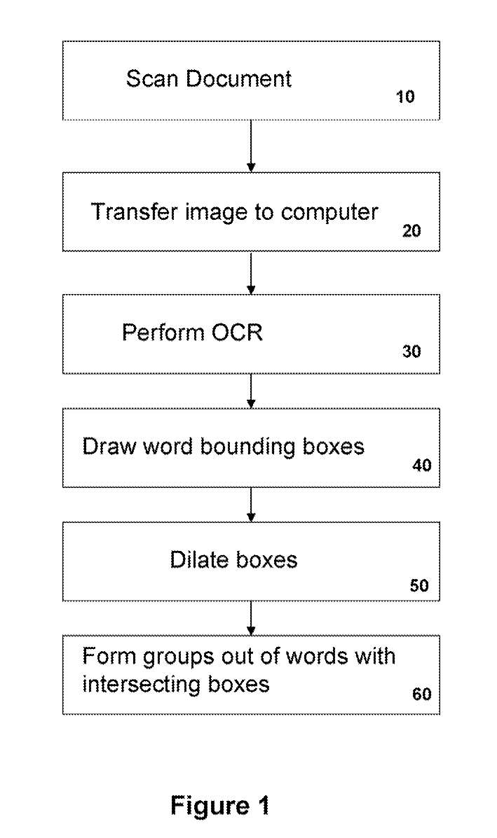

With reference to FIG. 1, a document is scanned 10 such that an electronic image of the document is created. Typically this will be an image composed of a number of pixels. The document may be a physical document such as a products receipt, business card or article. The document may already be an electronic form already such as an image found on the web or otherwise provided (such as through email). The term scanning is meant to incorporate more than using a traditional scanner but also includes any scanning device, faxing and digital photography or any other method of creating an electronic image suitable for OCR processing, whether now known or hereinafter created. The scanning device may be stationary or portable.

A typical system for implementing the invention will include a scanner (or other device such as fax or digital camera) and a computer. The computer will have a software program for interfacing with the scanner and an optical character recognition software program. It will also have a software program to take the output of the OCR program, create word boundary boxes, dilate the boxes and make groups of words based on overlapping dilated boxes.

The scanned image is then transferred 20 to a computing device, in the preferred embodiment this is a general purpose computer such as a PC. However, the computing device may also be a personal digital assistant, mobile phone, scanner with integrated computational power or some other dedicated digital processor. It will be obvious that the computing tasks described may be divided between the scanning device and the computer in any manner and such divisions set forth herein are exemplary is not meant to limit the invention. For instance, OCR algorithms will be described below as being performed by a computer, but this task may also be performed by the scanning device. While commercially available OCR programs may be used to perform certain tasks described herein, clearly custom software may also be used for these tasks. Further, the division between OCR processing and post-OCR processing is not meant to limit the invention. For instance the OCR software might provide output with word boxes instead of word edges and such embodiments meant to be included within the scope of the invention.

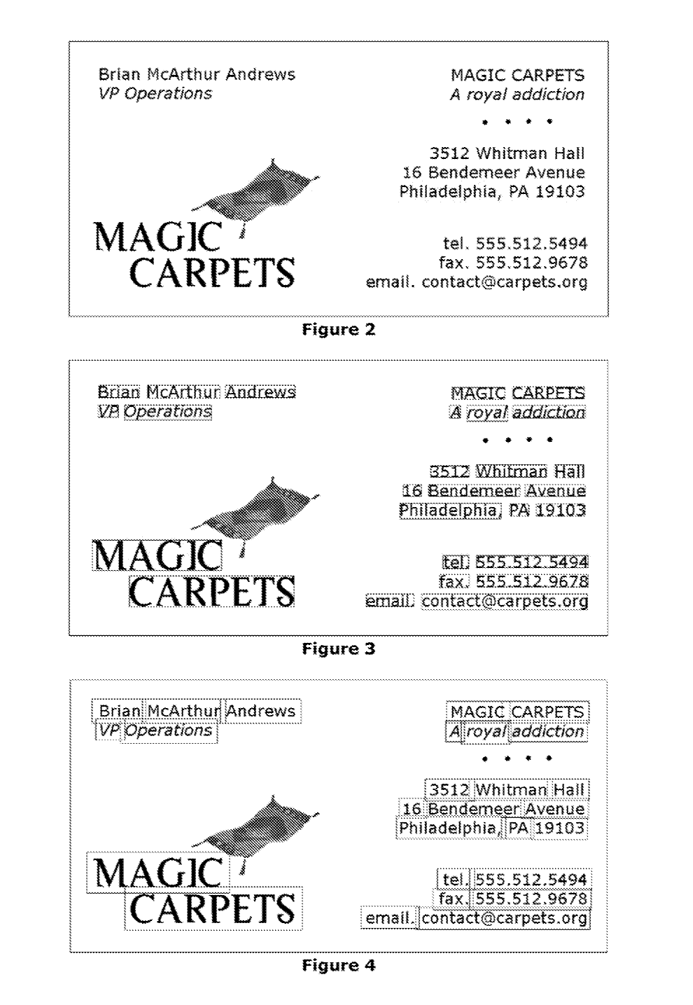

The computer then runs 30 an OCR software routine which extracts text information from the image. In addition to the actual text letters, typical OCR programs also provide information on words, text position, and position of word edges. While typically OCR routines are executed in software, the routines, as well as any other software function mentioned herein, may be embedded into hardware chips. Using the information retrieved from the OCR software, word bounding boxes are drawn 40 around each word recognized. FIG. 2 shows a typical image of a business card with a number of word groupings and FIG. 3 shows the business card after the word bounding boxes are drawn.

Next each of the boxes is dilated (expanded) 50 by a factor with the result. Boxes which are close to each other will overlap during this process as shown in FIG. 4. The words that have overlapping boxes are put into the same group 60 and can then be analyzed as text that is physically in the same region of the image.

In a preferred embodiment the dilation factor is an empirically derived constant used to determine the magnitude of dilation.

In another embodiment the dilation factor is adjustable. For instance, the XML information on font size can be used to scale the dilation factor accordingly. For example, letters of a larger font size have greater white spacing between them. In such a case the dilation factor may be dynamically scaled accordingly, increasing it in this case by a certain percentage. This would ensure that individual letters are not recognized as separate zones but instead recognized as letters of a word all within the same zone.

In a preferred embodiment the dilation factor is between 0.1 and 0.3, meaning each box size is increased between 10% and 30%.

The use of the term drawing is not meant to indicate the physical act of drawing boxes, but the mathematical act or creating boundaries around text words as calculated by a computer.

In a preferred embodiment these boxes are grouped together such that no two boxes in two different groups overlap and the grouping yields the maximum number of groups possible (i.e. none of the groups can be further sub-divided into more groups). This grouping can be done in any of a number of publicly-known standard procedures such as a series of nested loops to group together words that are close—a standard though arguably not the most efficient procedure. Another way to perform this grouping is by using set theory—a relation can be defined over whether two words are close after dilation, using which the set of words can be partitioned into equivalence classes each of which will correspond to a text zone. In one preferred embodiment, described in more detail herein, a procedure based on graph theory is used to calculate the groups.

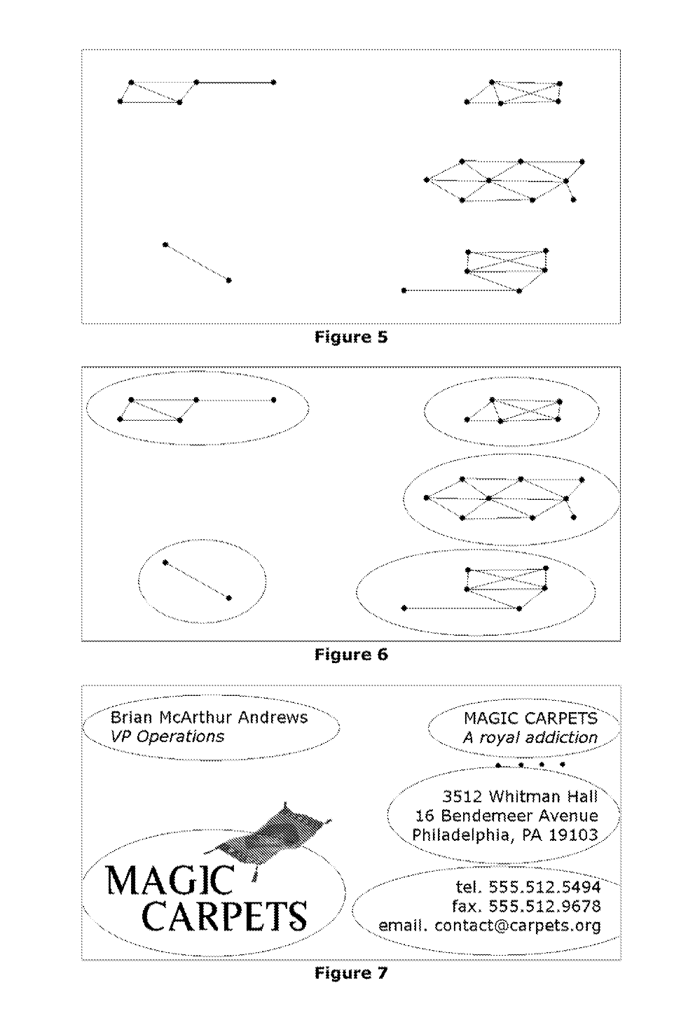

A word graph is constructed such that there is a one-to-one correspondence between the vertices of this graph and the words recognized by the OCR as shown in FIG. 5. A line is drawn between two vertices if and only if the word bounding boxes of the corresponding words overlap upon dilation. Since any two words whose word bounding boxes overlap upon dilation will be close to each other and should therefore belong to the same group, there will be a one-to-one correspondence between the connected components of the word graph and the text groups on the input image. Words which are interconnected on the graph are put into the same group as shown in FIG. 6. A Breadth First Search (BFS) or a Depth First Search (DFS)—or any other relevant technique—can be performed on the graph to identify these connected components. Finally, the words inside each text zone can be sorted to restore the order in which they occur on the input document as shown in FIG. 7. Each group of words can then be analyzed separately to determine what type of information it contains and how such information should be processed. For example, on FIG. 7, once the term VP is detected in word group on the top left of the image, the computer software can be designed to expect the vice-presidents name to be in the same word group.

The techniques described heretofore may be implemented by any number of algorithms and the invention is not intended to be limited to a particular mathematical technique. However, the inventors have found the mathematical calculation described to be a useful technique for implementing the invention. This technique is described below for exemplary purposes only and is not intended to limit the scope of the invention.

Definitions:

For purposes of the mathematical equations that follow terms will be given precise mathematical definitions. These definitions are not meant to limit the generality of the term as used above or in the claims.

Word (W)—A word is defined as any contiguous set of non-space characters recognized on the document.

Word bounding box (WBB)—The word bounding box of a word is the smallest rectangle that can be drawn on the document such that the word lies completely inside the rectangle.

Word edge (e)—A word edge is an integer defined in one of the following ways:
e_{left}=distance of the left edge of the WBB from the left edge of the document image
e_{right}=distance of the right edge of the WBB from the right edge of the document image
eₜₒₚ=distance of the top edge of the WBB from the top edge of the document image
e_{bottom}=distance of the bottom edge of the WBB from the bottom edge of the document image

Many commercially available OCR software is able to identify and return the word edges of the WBB along with the recognized word.

Word boundary (WB)—A word boundary is the ordered set of four word edges {e_{left}, e_{right}, eₜₒₚ, e_{bottom}} of the WBB.

Dilation—Dilation of the word boundary refers to a scaling of its four word edges by a dilation factor (D_{f}). After dilation,
e_{left}=e_{left}*(1−D_{f})e_{right}=e_{right}*(1+D_{f})
eₜₒₚ=eₜₒₚ*(1−D_{f})
e_{bottom}=e_{bottom}*(1+D_{f})

Crossing—Two word boundaries WB1 and WB2 are said to cross each other upon dilation if there exist at least two word edges e₁ [symbol] WB1 and e₂ [symbol] WB2 such that one of the following is true:
a) 1=left AND 2=right
b) 1=right AND 1=left
c) 1=top AND 2=bottom
d) 1=bottom AND 2=top

AND one of the following is true:
a) e₁-e₂≦0 before dilation AND e₁-e₂≧0 after dilation
b) e₁-e₂≧0 before dilation AND e₁-e₂≦0 after dilation

Closeness—Two words are said to be close if their word boundaries cross upon dilation.

Procedure:

The document whose text zones need to be identified is scanned and any commercial OCR software which can identify the edges of the word bounding boxes is used to perform character recognition on the scanned image. The proposed method is then called to group the recognized words into zones. The zones thus identified are then returned. The procedure groups words which are close to each other, i.e. two words whose word boundaries cross upon dilation.

At the first step, the text recognized from the scanned image by the OCR is analyzed and separated into words which are then used to construct the word set:
S={w₁, w₂, w₃, w₄ . . . wₙ}, where n=number of words recognized

A word graph G of n vertices is then constructed wherein each vertex v_{wx} corresponds to the word wₓ in the set S:
G=(V,E), where V={v_{w1}, v_{w2}, v_{w3}, v_{w4} . . . v_{wn}} and E=empty set

Then, for all pairs of words (wₓ, w_{y}) an edge (not to be confused with the word edge on the document image defined above) is drawn between v_{wx} and v_{wy} in G if wₓ and w_{y} are close.

Once the graph G is complete i.e. there exists an edge between every pair of vertices that correspond to two close words, the words are grouped together into zones. Two words will belong to the same zone if either they are close to each other or if they are close to a common set of words (a word wₓ can be said to be close to a set of words S, if the corresponding subgraph G_{S} U{wₓ} is connected in G).

Thus, at this stage, each connected component cₓ of the graph G represents a text zone. A Breadth First Search (BFS) or a Depth First Search (DFS)—or any other relevant technique—can be performed on the graph G to identify its connected components, and hence the corresponding text zones.

It should be noted that a connected component C_{c} of a graph G_{c} is defined as a non-empty subset of its vertices' set V_{c}, such that either:
C_{c} contains only one vertex; OR
There exists a path between any pair of vertices in C_{c} AND there exists no path between a vertex in C_{c} and a vertex in V_{c} but not in C_{c}.

Finally, the words inside each text zone are sorted and arranged into lines to restore the order in which they occur on the input document.

The benefits described above are not necessary to the invention, are provided by way of demonstration and are not intended to in any way limit the invention.

The particular embodiment described herein is provided by way of example and is not meant in any way to limit the scope of the claimed invention. It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service

We claim:

1. A computer based method of processing text on a document comprising:
receiving an electronic image of a document with text;
processing the electronic image to obtain words and word positions for the text on the document;
generating word bounding boxes around each word based;
dilating the word bounding boxes by a dilation factor; and
grouping together the words that have intersecting word bounding boxes intersect.

2. The method of claim 1 wherein the step of grouping is accomplished by:
creating a vertex for each word bounding box;
connecting with lines the vertices that represent word bounding boxes that overlap; and
grouping together the words that are represented by vertices that are interconnected with lines.

3. The method of claim 1 wherein the word bounding boxes are generated based upon the position word edges.

4. The method of claim 1 wherein the dilation factor is preset or is adjusted during the process of dilation.

5. The method of claim 1 wherein the dilation factor is approximately in the range of 0.1 and 0.3.

6. The method of claim 1 wherein the document is a receipt, business card, invoice, article or web page.

7. The method of claim 1 wherein the image is created by scanning, digital photography or faxing.

8. A computer system of processing text on a document comprising:
a scanning device for creating a electronic image of the document;
a computing device in communication with the scanning device; and
software execution on the scanning device or the computing device for performing the following steps:
processing the electronic image to obtain words and position of word edges for the text on the document;
generating word bounding boxes around each word based on the word edges;
dilating the word bounding boxes by a dilation factor; and
grouping together the words that have intersecting word bounding boxes intersect.

9. The computer system of claim 8 wherein the step of grouping is accomplished by:
creating a vertex for each word bounding box;
connecting with lines the vertices that represent word bounding boxes that overlap;
and grouping together the words that are represented by vertices that are interconnected with lines.

10. The computer system of claim 8 wherein the word bound boxes are generated based upon the position word edges.

11. The computer system of claim 8 wherein the dilation factor is preset or is adjusted during the process of dilation.

12. The computer system of claim 8 wherein the dilation factor is approximately in the range of 0.1 and 0.3.

13. The computer system of claim 8 wherein the document is a receipt, business card, invoice, article or web page.

14. The computer system of claim 8 wherein the image is created by scanning, digital photography, or faxing.

15. The computer system of claim 8 wherein the scanning device is an optical scanner, fax, or digital camera.

16. The computer system of claim 8 wherein the scanning device is stationary or portable.
